(19) United States
(12) Patent Application Publication
(10) Pub. No.: US 2009/0279619 A1
(43) Pub. Date: Nov. 12, 2009

(54) METHOD AND APPARATUS FOR CELL EDGE TRANSMISSION PERFORMANCE ENHANCEMENT FOR TDS-OFDM

(75) Inventors: LIN YANG, FREMONT, CA (US); QIN LIU, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 12/116,999

(22) Filed: May 8, 2008

(51) Int. Cl. H04L 27/28

(52) U.S. Cl. 375/260

(57) ABSTRACT

In a communication system with multiple base stations having at least one base station with communications overlaps with at least another base station, a method is provided. The method comprising the steps of: characterizing the users into a first group and a second group, and adjusting some PN lengths of transmitted information for one group of users. The system includes users of a TDS-OFDM system,

### CROSS-REFERENCE TO OTHER APPLICATIONS

The following applications of common assignee and filed on the same day herewith are related to the present application, and are herein incorporated by reference in their entireties:

U.S. patent application Ser. No. ______ with attorney docket number LSFFT-035.

U.S. patent application Ser. No. ______ with attorney docket number LSFFT-036.

U.S. patent application Ser. No. ______ with attorney docket number LSFFT-037.

U.S. patent application Ser. No. ______ with attorney docket number LSFFT-038.

U.S. patent application Ser. No. ______ with attorney docket number LSFFT-039.

U.S. patent application Ser. No. ______ with attorney docket number LSFFT-040.

U.S. patent application Ser. No. ______ with attorney docket number LSFFT-041.

### FIELD OF THE INVENTION

The present invention relates generally to an application in a TDS-OFDM system, more specifically the present invention relates to cell edge transmission performance enhancement using an adaptive PN length and the AMC code for the TDS-OFDM systems.

### BACKGROUND

Having reliable cell edge transmission and reception is a challenging task in cellular network applications, especially in an application relating to control information reception and uplink transmission. Adaptive modulation and coding (AMC) and power control are used in many wireless systems to improve performance. Typically, power levels in both uplink and downlink are increased in order to improve performance. However, increasing both uplink and downlink power will not only increase the received signal power, but also enhance the interference power. This poses a dilemma and is desirous to find a suitable solution.

Typically in a TDS-OFDM system, both downlink and uplink transmit frames in which each frame consists of certain number of OFDM symbols. The radio resource is allocated among the two-dimensional frequency-time plane.

On the cell edges, co-channel interference is a major problem and the signal-to-interference ratio (SNR) is low. Thus, it is a challenging task to demodulate control information as well as information data, from a base station (BS) in the downlink. Similarly, it is difficult for BS to demodulate signals from mobile terminals on the cell edge due to low signal-to-interference ratio. As can be seen, by simply increasing transmission power is not an optimistic solution and may further face problems in many applications.

### SUMMARY OF THE INVENTION

In TDS-OFDM systems, where both uplink and downlink use TDS-OFDM transmission, and both uplink and downlink adopt frame structures, in which each frame includes certain number of OFDM symbols. Inside each frame, some OFDM symbols are allocated to cell edge users, some are allocated to control information and others are allocated to information data. All the PN lengths and coding schemes adapt to transmission environments and applications to keep reliable reception of downlink control data, downlink cell edge user data, and uplink transmission data. For downlink control information and edge users, longer PN codes, more redundant channel codes, and low-order modulation schemes are used in both down link and uplink to increase reception performance. The longer PN codes improve reception performance without the need for increasing transmission power.

In a communication system with multiple base stations having at least one base station with communications overlaps with at least another base station, a method is provided. The method comprising the steps of: characterizing the users into a first group and a second group, and adjusting some PN lengths of transmitted information for one group of users. The system includes users of a TDS-OFDM system,

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a MIMO TDS-OFDM communication system in accordance with some embodiments of the invention.

FIG. 2 is an example of a symbol composition in accordance with some embodiments of the invention.

FIG. 3 is an example of a frame in accordance with some embodiments of the invention.

FIG. 3A is a more detailed depiction of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to adjusting a PN length for edge users in a TDS-OFDM system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of adjusting a PN length for edge users in a TDS-OFDM system described herein. The non-processor circuits may include, but are not limited to, a radio receiver, a radio transmitter, signal drivers, clock circuits, power source circuits, and user input devices. As such, these functions may be interpreted as steps of a method to perform adjusting a PN length for edge users in a TDS-OFDM system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

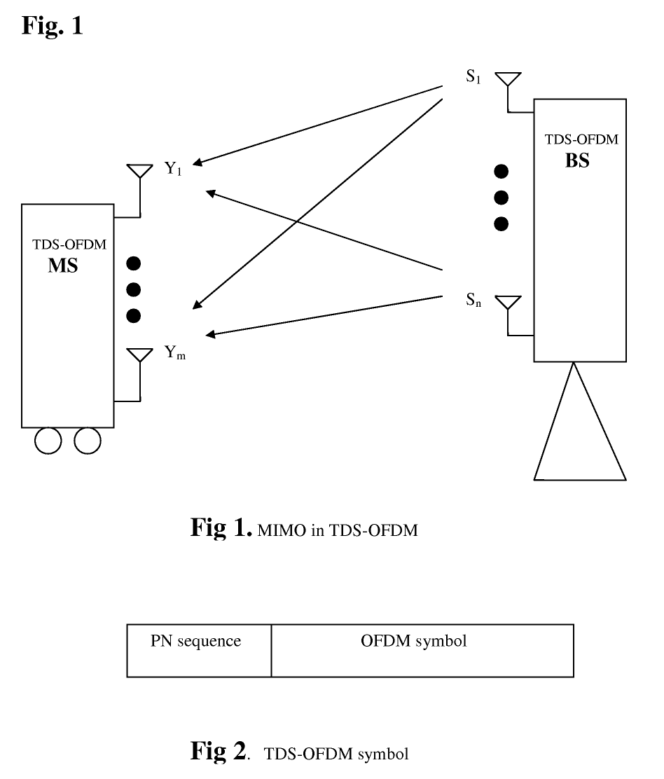

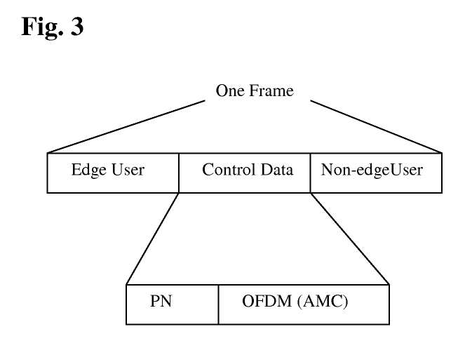

Referring to FIGS. 1-3A, a plurality of base stations (BS) 102 (only one shown) each has two or more BS antennas 104. Each one of the antennas 104 respectively transmits signals S₁, S₂, . . . , Sₙ. At least one of the signals Si among the transmitted signals S₁, S₂, . . . , Sₙ uses the format shown in FIG. 2 employing a pseudo noise (PN) sequence Pᵢ as guard interval that may be among a plurality of PN acting as guard intervals interposed or inserted between data or symbols such as OFDM symbols. Mobile station (MS) 106 receives signals using multiple MS antennas 108. Each one of the antennas 108 is adapted to receive from all transmitted signals including the transmitted signals S₁, S₂, . . . , Sₙ from BS 102 as well as other base stations (not shown). Mobile station 106 comprises a receiver 300 for receiving signals from surrounding base stations. The receiver 300 in mobile station 106 is adapted such that all the PN sequences of substantially all the transmitted signals from substantially all the base stations including BS 102 in a predetermined neighborhood or geographic area are known to the base station 106. In other words, BS 102 and MS 106 know the PN sequences within a wireless communication neighborhood. This is advantageous in a TDS-OFDM system in that the guard intervals are the PN sequences. The receiver 300 is adapted to use the PN codes to perform a correlation in order to find a timing of each path. Both base station 102 and mobile station 106 comprise receivers 300.

Referring specifically to FIG. 2, a packet of transmission or a received packet having PN sequence as guard interval among a plurality of guard intervals (only one shown) is shown. The packet is positioned sequentially within a frame among a multiplicity of packets. As can be appreciated, PNs are disposed between the OFDM symbols. It is noted that the present invention contemplates using the PN sequence disclosed in U.S. Pat. No. 7,072,289 to Yang et al which is hereby incorporated herein by reference.

It is advantageous over other systems in the use of PNs as guard intervals between symbols or data in such systems as TDS-OFDM systems. The advantages include improved channel estimation time, improved synchronization time, and less need to insert more known values such as pilots in what would be used or reserved for data.

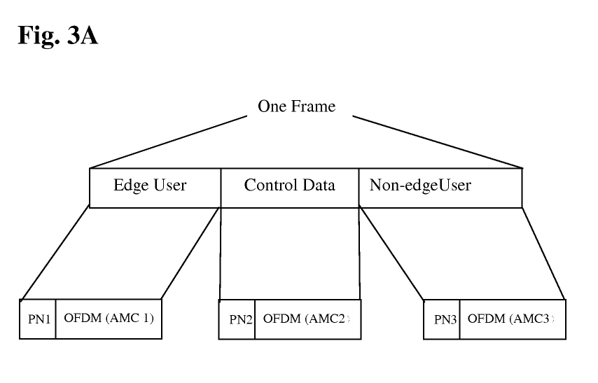

Referring specifically to FIGS. 3-3A, a single frame comprising at least one sub-frame for edge user, at least one sub-frame for control data, and at least one sub-frame for non-edge user are provided. The sub-frame for edge user of the single frame can further be subdivided into a PN1 sequence acting guard interval, and an OFDM (AMC1). PN1 sequence has a predetermined length d1.

The sub-frame for control data of the single frame can further be subdivided into a PN2 sequence acting guard interval, and an OFDM (AMC2). PN2 sequence has a predetermined length d2.

The sub-frame for non-edge user of the single frame can further be subdivided into a PN3 sequence acting guard interval, and an OFDM (AMC3). PN3 sequence has a predetermined length d3. Some OFDM symbols can use longer PN codes than a standard length. In other words, PN1 sequence is longer than PN3 sequence (d1>d3).

Base station 102 (BS) transmits signals S₁, S₂, . . . , Sₙ through multiple antennas 104. Signals subject to transmission at the i-th antenna Si uses the format in FIG. 2 employing PN sequence Pᵢ. A mobile station 106 (MS) having a receiver receives signals using multiple antennas. The received signal at j-th antenna comprises Yⱼ (j being a positive integer ranging between 1 and m). Yⱼ comprises signals received from all transmitted signals S₁, S₂, . . . , Sₙ. The receiver 300 knows or is disposed to access and/or process the PN sequences of all transmitted signals S₁, S₂, . . . , Sₙ. The receiver 300 can feedback demodulation performance to BS 102. As can be seen, the receiver demodulation performance reflects channel conditions. Furthermore, based upon the receiver demodulation performance, an indication or a value regarding a single or multiple edge users may be achieved. In other words, the value or a parameter relating to the receiver demodulation performance comprises an indication regarding at least on edge user. Both downlink and uplink transmit frames of data, in which each frame comprises multiple OFDM symbols. BS 102 can detect at least on edge user based on uplink demodulation performance and can further detect edge users based on feedback from mobile users. MS 106 can detect its edge location by using known signals from BS 102 or from demodulation performance. Some OFDM symbols can use longer PN codes than a standard length. Further, lower code rate of ½ is more redundant than higher code rate of ¾ since there is 1 added bit per each useful bit for ½ whereas 1 added per every 3 for ¾. Further, some OFDM symbols can use more redundant channel codes as compared with other OFDM symbols. AMC for Adaptive Modulation and Coding is a way of achieving high spectral efficiency on fading channels. The core idea is to dynamically change the modulation and coding schemes in subsequent frames with the objective of adapting the overall spectral efficiency to the channel condition. In our case, adaptive PN length is new due to TDS-OFDM structure. Still further, some OFDM symbols can use low-order modulation schemes such as from 64 QAM to 16 QAM, 4 QAM, and QPSK etc. which are allocated to control data and edge users. Other OFDM symbols are allocated to normal data transmission rate, such as the rate typically allocated to non-edge users.

BS 102 can subsequently adjust the PN code length, the channel code redundancy, and the modulation scheme order based upon the detection of edge users and control data transmission. The users, not on the cell edge, but face worse channel environment may be considered as edge users.

It is noted that the BSs can operate under non-TDS mode. In such cases, only modulation schemes (such as 64 qam, 16 qam, 4 qam) and coding schemes can be adjusted. PN is not present and so cannot be adjusted.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. In a communication system with multiple base stations having at least one base station with communications overlaps with at least another base station, the system includes users of a TDS-OFDM system, a method comprising the steps of:
characterizing the users into a first group and a second group; and
adjusting some PN lengths of transmitted information for one group of users.

2. The method of claim 1, wherein users of the first group are located in a proximity of the communications overlaps.

3. The method of claim 2, wherein the adjusting step comprises increase the PN lengths.

4. The method of claim 1, wherein users of the second group are located outside or away from a proximity of the communications overlaps.

5. The method of claim 4, wherein the adjusting step comprises maintaining existing PN lengths.

6. The method of claim 1, wherein at least one user is associated with a mobile station.

7. The method of claim 6, wherein the mobile station comprises multiple antennae.

8. The method of claim 1, wherein the base station comprises multiple antennae.

9. The method of claim 1 further comprising the step of transmitting a first OFDM symbol using more redundant channel codes as compared with transmitting a second OFDM symbol.

10. The method of claim 1 further comprising the steps of: transmitting a first OFDM symbol using a first modulation scheme, transmitting a second OFDM symbol using a second modulation scheme; wherein the first modulation scheme is a lower order scheme as compared with the second modulation scheme.

11. In a communication system comprising:
A plurality of base stations having at least one base station with communications overlaps with at least another base station;
users of a TDS-OFDM system; and
a method comprising the steps of:
characterizing the users into a first group and a second group; and
adjusting some PN lengths of transmitted information for one group of users.

12. The method of claim 11, wherein users of the first group are located in a proximity of the communications overlaps.

13. The method of claim 2, wherein the adjusting step comprises increase the PN lengths.

14. The method of claim 11, wherein users of the second group are located outside or away from a proximity of the communications overlaps.

15. The method of claim 4, wherein the adjusting step comprises maintaining existing PN lengths.

16. The method of claim 11, wherein at least one user is associated with a mobile station.

17. The method of claim 16, wherein the mobile station comprises multiple antennae.

18. The method of claim 11, wherein the base station comprises multiple antennae.

19. The method of claim 11 further comprising the step of transmitting a first OFDM symbol using more redundant channel codes as compared with transmitting a second OFDM symbol.

20. The method of claim 11 further comprising the steps of: transmitting a first OFDM symbol using a first modulation scheme, transmitting a second OFDM symbol using a second modulation scheme; wherein the first modulation scheme is a lower order scheme as compared with the second modulation scheme.
